(19) United States
(12) Patent Application Publication
(10) Pub. No.: US 2022/0027710 A1
(43) Pub. Date: Jan. 27, 2022

(54) METHOD AND APPARATUS FOR DETERMINING NEURAL NETWORK ARCHITECTURE OF PROCESSOR

(71) Applicant: Samsung Electronics Co., Ltd., Suwon-si (KR)

(72) Inventors: Fengtao XIE, Xi'an (CN); Fangfang DU, Xi'an (CN); Fang LIU, Xi'an (CN); Liang LI, Xi'an (CN); Pengfei ZHAO, Xi'an (CN); Ke LU, Xi'an (CN)

(73) Assignee: Samsung Electronics Co., Ltd., Suwon-si (KR)

(21) Appl. No.: 17/376,302

(22) Filed: Jul. 15, 2021

(51) Int. Cl. G06N 3/04; G06F 17/18; G06N 3/08

(52) U.S. Cl. CPC G06N 3/0454; G06N 3/08; G06F 17/18

(57) ABSTRACT

A method and apparatus for determining a neural network architecture of a processor are provided. The method of determining a target neural network architecture, the method comprising obtaining a first neural network architecture, searching for the first neural network architecture based on a loss function, in response to a first search end condition not being satisfied, and determining a target neural network architecture used in a processor, based on a result of the searching, wherein the loss function is based on a processor computation cost.

### CROSS-REFERENCE TO RELATED APPLICATIONS

This application claims the benefit under 35 USC 119(a) of Chinese Patent Application No. 202010731469.8, filed on Jul. 27, 2020, in the China National Intellectual Property Administration and Korean Patent Application No. 10-2021-0061557, filed on May 12, 2021, in the Korean Intellectual Property Office, the entire disclosures of which are incorporated herein by reference for all purposes.

### BACKGROUND

### Field

The following description relates to a method and apparatus for determining a neural network architecture of a processor.

### Description of Related Art

The neural network or an artificial neural network (ANN) may generate mappin g between input patterns and output patterns, and may have a generalization capabilit y to generate a relatively correct output with respect to an input pattern that has not been used for training. The neural network may refer to a general model that has an ability to solve a problem, where nodes form the network through synaptic combinatio ns change a connection strength of synapses through training.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method of determining a target neural network architecture, the method comprising obtaining a first neural network architecture, searching for the first neural network architecture based on a loss function, in response to a first search end condition not being satisfied, and determining a target neural network architecture used in a processor, based on a result of the searching, wherein the loss function is based on a processor computation cost.

The loss function may be based on the processor computation cost and a prediction error in a training of the first neural network architecture.

The processor computation cost may include any one or any combination of a time-consuming hyperparameter and a power-consuming hyperparameter, the time-consuming hyperparameter may be determined based on a time to access a memory when the processor trains the first neural network architecture, and the power-consuming hyperparameter may be based on power consumed to access a memory when the processor trains the first neural network architecture.

The first neural network architecture may include at least one structure, the at least one structure may be formed by stacking at least one network block, the at least one network block may include at least one mix operation, and the at least one mix operation may be connected to at least one primitive operation.

The at least one mix operation may be determined by obtaining a second neural network architecture, searching for the second neural network architecture, in response to a second search end condition not being satisfied, and determining a mix operation of the second neural network architecture based on a result of the searching for the second neural network.

The second neural network architecture may include at least one network block, the at least one network block may include at least one candidate combination operation based on a network block configuration rule of the at least one network block, and the at least one candidate combination operation may include at least one of a plurality of primitive operations.

The method may include determining the network block configuration rule based on artificial settings.

The method may include determining the network block configuration rule based on a network block structure of the processor.

The determining of the network block configuration rule based on the network block structure of the processor may include obtaining one or more candidate neural networks by transforming an initial neural network based on at least one transformation scheme in a test platform of the processor, obtaining a running state of each of the one or more candidate neural networks in the test platform, and determining the network block configuration rule based on the running state of each of the one or more candidate neural networks.

The obtaining of the running state may include obtaining a time consumed by each of the one or more candidate neural networks to process a reference data set in the test platform.

The obtaining of the one or more candidate neural networks may include any one or any combination of horizontally expanding the initial neural network, vertically expanding the initial neural network, performing parallel splitting on a single operation of the initial neural network, changing a size of a feature map of the initial neural network, and changing a number of channels of the initial neural network.

The network block configuration rule may be determined based on any one or any combination of a priority relationship between vertical expansion and horizontal expansion, a number of operations obtained by parallel splitting of a single operation, a number of channels, and a size of a feature map.

In another general aspect, there is provided a target neural network architecture determination apparatus, the apparatus comprising a processor configured to obtain a first neural network architecture, to search for the first neural network architecture based on a loss function, in response to a first search end condition not being satisfied, and to determine a target neural network architecture used in the processor, based on a result of the searching, wherein the loss function is based on a processor computation cost.

The processor computation cost may include any one or any combination of a time-consuming hyperparameter and a power-consuming hyperparameter, the time-consuming hyperparameter may be determined based on a time to access a memory when the processor trains the first neural network architecture, and the power-consuming hyperparameter may be based on power consumed to access a memory when the processor trains the first neural network architecture.

The first neural network architecture may include at least one structure, the at least one structure may be formed by stacking at least one network block, the at least one network block may include at least one mix operation, and the at least one mix operation may be connected to at least one primitive operation.

The processor may be configured to obtain a second neural network architecture, search for the second neural network architecture, in response to a second search end condition not being satisfied, and determine a mix operation of the second neural network architecture based on a result of the searching for the second neural network.

The second neural network architecture may include at least one network block, the at least one network block may include at least one candidate combination operation based on a network block configuration rule of the at least one network block, and the at least one candidate combination operation may include at least one of a plurality of primitive operations.

The processor may be configured to determine the network block configuration rule based on a network block structure of the processor.

The processor may be configured to obtain one or more candidate neural networks by transforming an initial neural network based on at least one transformation scheme in a test platform of the processor, obtain a running state of each of the one or more candidate neural networks in the test platform, and determine the network block configuration rule based on the running state of each of the one or more candidate neural networks.

Other features and aspects will be apparent from the following detailed description, the drawings, and the claims.

### BRIEF DESCRIPTION OF THE DRAWINGS

FIG. 1 illustrates an example of a search method to determine a target neural network architecture of a processor.

FIG. 2 illustrates an example of determining a mix operation from a plurality of primitive operations.

FIG. 3 illustrates an example of determining a network block configuration rule based on a desirable network block structure of a processor.

FIG. 4 illustrates

an example of a search method to determine a neural network architecture of a processor when the processor is a neural network processing unit (NPU).

FIG. 5 illustrates an example of determining a network block configuration rule based on a desirable network block structure of a processor.

FIG. 6 illustrates an example of determining a mix operation from primitive operations.

FIG. 7 illustrates an example of a search method to determine a neural network architecture of a processor.

FIG. 8 illustrates an example of a relationship of mix operations in one network block of a first neural network architecture.

FIG. 9 illustrates an example of a target neural network architecture determination apparatus.

FIG. 10 illustrates an example of a computing device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

Although terms of “first,” “second,” , A, B, (a), or (b) are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

As used herein, the singular forms are intended to include the plural forms as well, unless the context clearly indicates otherwise. As used herein, the term “and/or” includes any one and any combination of any two or more of the associated listed items. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

The use of the term “may” herein with respect to an example or embodiment (e.g., as to what an example or embodiment may include or implement) means that at least one example or embodiment exists where such a feature is included or implemented, while all examples are not limited thereto.

Examples may be implemented as various types of products, for example, laptop computer, a mobile phone, a smart phone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, a digital television (DTV), an artificial intelligence (AI) speaker, a home appliance such as a television, a smart television, a refrigerator, a smart home device, a vehicle such as a smart vehicle, an Internet of Things (loT) device, or a smart device. The smart device may be implemented as a smart watch, a smart band, smart glasses, or a smart ring. Hereinafter, examples will be described in detail with reference to the accompanying drawings. Like reference numerals in the drawings denote like components, and thus their description will be omitted.

A neural network includes a plurality of layers, such as an input layer, a plurality of hidden layers, and an output layer. Each layer of the neural network may include a plurality of nodes each referred to as an artificial neuron. Each node may indicate an operation or computation unit having at least one input and output, and the nodes may be connected to one another.

The input layer may include one or more nodes to which data is directly input without being through a connection to another node. The output layer may include one or more output nodes that are not connected to another node. The hidden layers may be the remaining layers of the neural network from which the input layer and the output layer are excluded, and include nodes corresponding to an input node or output node in a relationship with another node. According to examples, the number of hidden layers included in the neural network, the number of nodes included in each layer, and/or a connection between the nodes may vary. A neural network including a plurality of hidden layers may also be referred to as a deep neural network (DNN).

A weight may be set for a connection between nodes of the neural network. For example, a weight may be set for a connection between a node included in the input layer and another node included in a hidden layer. The weight may be adjusted or changed. The weight may determine the influence of a related data value on a final result as it increases, decreases, or maintains the data value.

The neural network may be a model with a machine learning structure designed to extract feature data from input data and provide an inference operation or prediction based on the feature data. The feature data may be data associated with a feature obtained by abstracting input data. If input data is an image, feature data may be data obtained by abstracting the image and may be represented in a form of, for example, a vector. The inference operation may include, for example, pattern recognition (e.g., object recognition, facial identification, etc.), sequence recognition (e.g., speech, gesture, and written text recognition, machine translation, machine interpretation, etc.), control (e.g., vehicle control, process control, etc.), recommendation services, decision making, medical diagnoses, financial applications, data mining, and the like.

To train a target model for a problem based on a training sample, a neural network architecture of the target model may need to be designed in advance. The neural network architecture may be obtained through a search, however, it may be difficult to guarantee that a processor is executed with further enhanced performance after a neural network architecture based on an existing neural network architecture search method is placed in the processor.

A search method to determine a neural network architecture of a processor is provided that collectively limits a search convergence of a neural network architecture based on a processor computation cost and a prediction error in a model training process, to ensure that the processor is executed at a high speed when the neural network architecture found by the search method is run on the processor.

The obtained neural network architecture may be trained as a target model for performing prediction of a problem, based on the training sample. The target model may be used to process a problem such as speech recognition, image recognition, or text recognition. For example, when a target neural network architecture for image data processing is used, each frame image of image data may be classified according to features of each frame image.

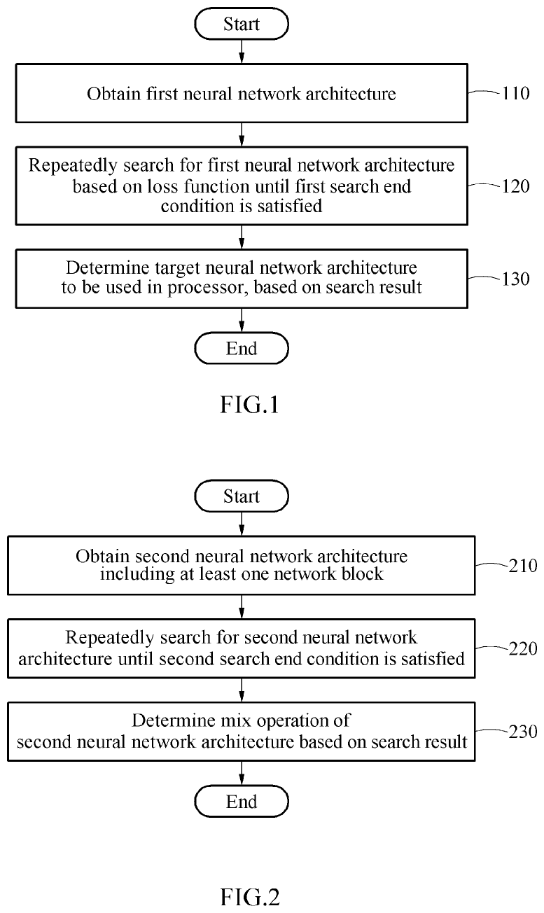

FIG. 1 is a diagram illustrating an example of a search method to determine a target neural network architecture of a processor. The operations in FIG. 1 may be performed in the sequence and manner as shown, although the order of some operations may be changed or some of the operations omitted without departing from the spirit and scope of the illustrative examples described. Many of the operations shown in FIG. 1 may be performed in parallel or concurrently.

One or more blocks of FIG. 1, and combinations of the blocks, can be implemented by special purpose hardware-based computer, such as a processor, that perform the specified functions, or combinations of special purpose hardware and computer instructions. Operations 110 to 130 may be performed by a target neural network architecture determination apparatus.

In operation 110, the target neural network architecture determination apparatus may obtain a first neural network architecture.

In an example, an architecture of a neural network may include a connection relationship between nodes of a network. The architecture of the neural network may be expressed by, for example, a directed acyclic graph (DAG) or a structure such as a network block. Thus, all variable elements of a neural network architecture may construct the entire search space of a network architecture.

In operation 120, the target neural network architecture determination apparatus may repeatedly search for the first neural network architecture based on a loss function until a first search end condition is satisfied.

The loss function may include at least one of a processor computation cost part or a prediction error in a model training process.

In an example, the processor may perform computation of a deep neural network. For example, the processor may be an accelerator or a dedicated processor that has an acceleration function for a neural network. The processor may be a data processing device implemented by hardware including a circuit having a physical structure to perform desired operations. For example, the desired operations may include code or instructions included in a program. For example, the hardware-implemented data processing device may include for example, a microprocessor, a microprocessor, single processor, independent processors, parallel processors, single-instruction single-data (SISD) multiprocessing, single-instruction multiple-data (SIMD) multiprocessing, multiple-instruction single-data (MISD) multiprocessing, multiple-instruction multiple-data (MIMD) multiprocessing, a microcomputer, a processor core, a multi-core processor, and a multiprocessor, a central processing unit (CPU), an application-specific integrated circuit (ASIC), and a field-programmable gate array (FPGA), a central processing unit (CPU), a controller and an arithmetic logic unit (ALU), a digital signal processor (DSP), a graphics processing unit (GPU), or an application processor (AP), a neural processing unit (NPU), or a programmable logic unit (PLU).

The target neural network architecture determination apparatus may automatically search for a target neural network architecture, to train a target model for performing prediction or inference of a problem, for example, a target model for speech recognition, image recognition or text recognition, based on a training sample.

Thus, the target neural network architecture determination apparatus may configure a training set and a validation set proportionally based on at least a portion of the training sample and may train and evaluate the first neural network architecture in a search space.

The target neural network architecture determination apparatus may evaluate the first neural network architecture using a processor-related loss function that reflects a processor computation cost as well as prediction error.

In operation 130, the target neural network architecture determination apparatus may determine a target neural network architecture that is to be used in the processor, based on a search result.

The target neural network architecture may be, for example, a first neural network architecture having a loss function corresponding to an optimal value.

The target neural network architecture determination apparatus may collectively limit a search convergence of a neural network architecture based on the processor computation cost part and the prediction error in the model training process, thereby guaranteeing that the processor is executed at a high speed when a determined neural network architecture is running in the processor.

For example, the processor computation cost may include at least one of a time-consuming hyperparameter and a power-consuming hyperparameter.

The time-consuming hyperparameter may be determined based on a time consumed to access a memory in a process in which the processor trains the first neural network architecture, and the power-consuming hyperparameter may be determined based on power consumed to access a memory in a process in which the processor trains the first neural network architecture.

The processor may be more sensitive to an amount of computation when accessing a dynamic random-access memory (DRAM) than an amount of computation in a process of training a model. Thus, the processor computation cost may be determined based on the time-consuming hyperparameter and/or the power-consuming hyperparameter.

The processor may access the DRAM when training a model, and accordingly the time-consuming hyperparameter and/or the power-consuming hyperparameter may be generated.

The time-consuming hyperparameter and/or the power-consuming hyperparameter may be obtained using at least one of the following schemes:

In a first scheme, Scheme a1, a time-consuming hyperparameter and/or a power-consuming hyperparameter included in the processor computation cost may be obtained through a test.

In a second scheme, Scheme a2, a time-consuming hyperparameter and/or a power-consuming hyperparameter included in the processor computation cost may be calculated through a standard parameter of the processor.

Hereinafter, an expression of the processor-related loss function will be described based on an example of the processor computation cost including a time-consuming hyperparameter used by the processor to access the DRAM in the process of training a model.

The processor-related loss function may be expressed as shown in Equation 1 below.

LOSS=L_{CE}(w,a)+λL_{DRAM}(a) [Equation 1]

In Equation 1, LOSS denotes the processor-related loss function, L_{CE}(w, a) denotes a prediction error part of a model training process, and L_{DRAM}(a) denotes a time-consuming hyperparameter used by the processor to access the DRAM in the process of training a model. Also, λ may be used to balance influences by an access to the DRAM on a search result, and a value of λ may indicate relative importance of an accuracy and an execution speed of a neural network architecture. When the value of λ increases, importance of the accuracy and the execution speed of the neural network architecture may increase.

The processor computation cost part may include a hyperparameter of a time used for an access to the DRAM, and may ensure that the processor has a high execution speed while a neural network architecture that is found in the search is being executed in the processor.

The processor computation cost may include a power hyperparameter used for an access to the DRAM, and may significantly reduce a power consumption of the processor while a neural network architecture found in searching is being executed in the processor.

The processor computation cost may include both a time-consuming hyperparameter and a power-consuming hyperparameter used for an access to the DRAM, may guarantee a high execution speed of the processor and may significantly reduce a power consumption of the processor while a neural network architecture that is found in searching is being executed in the processor.

The target neural network architecture determination apparatus may repeatedly perform a search in a search space of the first neural network architecture until the first search end condition is satisfied.

In an example, the first search end condition may be determined according to practical design requirements. In an example, the first search end condition may be satisfied on the happening of a condition, such as, for example, that a number of search iterations reaches a threshold number, a search time reaches a threshold time, or a value of a processor-related loss function corresponding to the found first neural network architecture satisfying a value condition.

The first neural network architecture may include at least one structure. Each of the at least one structure may include at least one network block. A corresponding network block may be regarded as a unit forming the first neural network architecture. Each network block may be filled with at least one mix operation connected to at least one primitive operation. In the present disclosure, the structure may also be referred to as a “step”.

Each network block in the first neural network architecture may be filled with the same number and type of mix operations or different numbers and types of mix operations. If one network block is filled with two or more mix operations, types of two mix operations in the network block may be the same or different.

A primitive operation may include at least one of convolution, deconvolution, an activation function, and pooling. The primitive operation may further include all operations available in a neural network, but all the operations are not listed herein. If a mix operation includes two or more primitive operations, types of two primitive operations of the mix operation may be the same or different.

For example, five mix operations may be provided. A first mix operation may include a single 1×1 convolution operation, a second mix operation may include two 1×1 convolution operations, and a third mix operation may include a single 1×1 convolution operation and a single 3×3 convolution operation. A fourth mix operation may include a single 3×3 convolution operation and two pooling operations, and a fifth mix operation may include three pooling operations. In an example, a composition form of mix operations is not limited, and mix operations may also be in a larger number of composition forms that are not listed herein.

In an example, the target neural network architecture determination apparatus may determine at least one mix operation, prior to operation 110, and may sequentially perform operations 110 to 130. Each mix operation may be connected to at least one primitive operation.

In an example, at least one mix operation may be determined in a set of candidate combination operations, and each of the candidate combination operations may include at least one primitive operation among preset primitive operations. Hereinafter, an example of a process of determining a mix operation will be described in detail.

When at least one mix operation is determined, operation 110 may include obtaining a first neural network architecture including at least one structure. Each of the at least one structure may be formed by stacking at least one network block, and a network block of each of the at least one structure may be filled with the at least one mix operation based on a network block configuration rule of the network block. The mix operation may be connected to at least one primitive operation.

In an example, prior to operation 110, the target neural network architecture determination apparatus may determine the network block configuration rule based on artificial settings. In another example, the target neural network architecture determination apparatus may determine the network block configuration rule based on a predetermined network block structure of the processor.

In an example, a number of structures included in the first neural network architecture may be determined according to practical design requirements. For example, the first neural network architecture may include only one step, or two or more steps.

For example, when the first neural network architecture includes two or more structures, the structures may be connected, and a scheme of connecting the structures may be determined according to practical design requirements.

In an example of the scheme of connecting the structures, a plurality of structures may be sequentially distributed in a first direction, and each of the structures may be connected to one or two neighboring structures in the first direction. The first direction may be identical to a transmission direction of a network node calculation result.

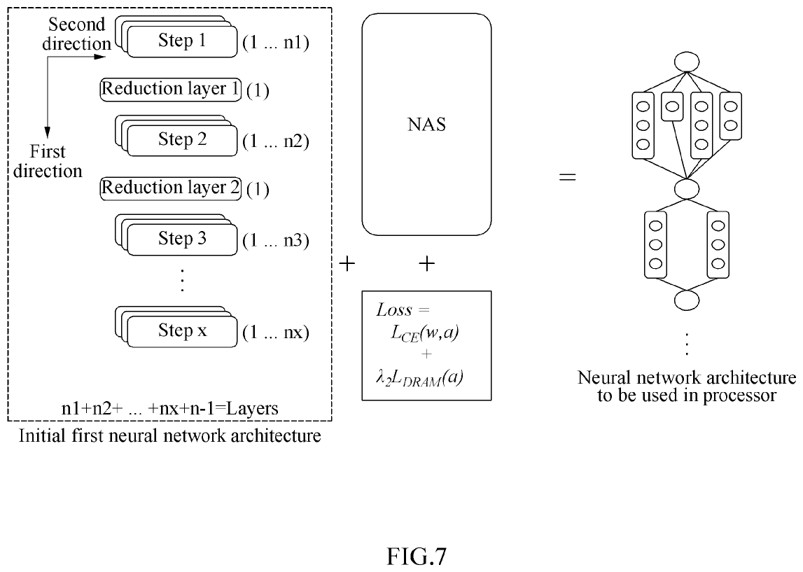

For example, a first structure (for example, a structure 1 of FIG. 7) may be connected to one next structure, a last structure (for example, a structure X of FIG. 7) may be connected to one previous structure, and each of the remaining structures (for example, a structure 2 of FIG. 7) may be connected to two neighboring structures disposed in front of and behind each of the remaining structures.

In an example, referring to FIG. 7, a first neural network may include the structures 1 to X, and the structures 1 to X may be sequentially distributed in the first direction. The structures 1 and 2 may be connected, the structures 2 and 3 may be connected, and the other structures may be connected in the same manner. In another example of the scheme of connecting the structures, a plurality of structures may be distributed in a first direction and a second direction, and each of the structures may be connected to a neighboring structure in the first direction and the second direction. A plurality of structures in an initial first neural network architecture may be connected using different distribution and connection schemes are considered to be well within the scope of the present disclosure.

The first direction and the second direction may not be physical directions, and may be introduced to distinguish all different distribution and connection schemes in the plurality of structures of the initial first neural network architecture.

In an example, the first neural network architecture may further include a reduction layer, and each reduction layer may include at least one network block. Structures may be connected to each other via a reduction layer.

In FIG. 7, the structures 1 to X may be sequentially distributed in the first direction, the structures 1 and 2 may be connected via a reduction layer 1, and the structures 2 and 3 may be connected via a reduction layer 2.

In an example, a number of network blocks included in each structure and a number of network blocks included in each reduction layer may be set in advance according to practical design requirements, or may be determined through training during a repeated process. For example, a structure may include only one network block, or may include two or more network blocks.

Each structure (or a reduction layer) may include the same number and type of network blocks or different numbers and types of network blocks. When one structure (or a reduction layer) is filled with two or more network blocks, types of two network blocks in the structure (or the reduction layer) may be the same or different.

In an example, when operation 120 is performed, the target neural network architecture determination apparatus may use, as a variable element, any one or any combination of a number of structures, a scheme of connecting structures, a number of network blocks in each structure, a scheme of stacking network blocks in each structure, and a scheme of filling each network block with mix operations and may determine a target neural network architecture through a search.

In another example, when operation 120 is performed, the target neural network architecture determination apparatus may use, as variable elements, any one or any combination of a number of network blocks in each structure, a scheme of stacking network blocks in each structure, and a scheme of filling each network block with mix operations, instead of changing a number of structures and a scheme of connecting structures, and may determine a target neural network architecture through a search.

Operation 120 may include a process of searching for each network block from the first neural network architecture and a process of searching for a scheme of filling each network block with a mix operation using a neural architecture search (NAS) based on the processor-related loss function.

In an example, a process of searching for a first neural network architecture may be a process of changing a current first neural network architecture to a first neural network architecture that satisfies a search condition. Any one or any combination of a number of structures of the current first neural network architecture, a scheme of connecting the structures, a number of network blocks in each of the structures, a scheme of stacking network blocks in each of the structures, and a scheme of filling each network block with mix operations may be changed. The target neural network architecture determination apparatus may train and validate the changed first neural network architecture.

In an example, when each first neural network architecture is trained and validated in a search space, the target neural network architecture determination apparatus may train a model of a first neural network architecture using a training set, and may validate the trained model using a validation set in response to training being performed at least one time.

In the model training process, the target neural network architecture determination apparatus may need to continue to calculate a value of the processor-related loss function. The target neural network architecture determination apparatus may evaluate the first neural network architecture using the value of the processor-related loss function, and may determine whether the first search end condition is satisfied based on the value of the processor-related loss function. For example, when a value of the processor-related loss function corresponding to a first neural network architecture found in searching satisfies a value condition, the target neural network architecture determination apparatus may determine that the first search end condition is satisfied.

As described above, the processor-related loss function may include the processor computation cost part and the prediction error part in the model training process. The prediction error part may be obtained using a validation set for validating a trained model, and the processor computation cost part may include a time-consuming hyperparameter generated by the processor accessing a DRAM in a process of training a model. An example of a scheme of obtaining the time-consuming hyperparameter will be described below.

The time-consuming hyperparameter may include a first sum of amounts of time consumed by all network blocks of the first neural network architecture to access the DRAM and a sum of weights of all mix operations of the first neural network architecture. The time-consuming hyperparameter used by the processor to access the DRAM in the process of training a model may be expressed as shown in Equation 2 below.

L_{DRAM}=k₀+k₁Σ_{y}^{Y}Σₙ^{N}L_DRAM_{yn}+k₂Σ_{y}^{Y}Σₙ^{H}Σₙ^{N}1×P_{ynm} [Equation 2]

In Equation 2, LDRAM denotes a time-consuming hyperparameter used by the processor to access the DRAM in the process of training a model, Σ_{y}^{Y}Σₙ^{N}L_DRAMyn denotes a sum of amounts of time consumed by all network blocks of the first neural network architecture to access the DRAM, and Σ_{y}^{Y}Σₙ^{N}Σₙ^{N}1×P_{ynm} denotes a sum of weights of all mix operations in the first neural network architecture. Also, k₀ denotes a constant term, k₁ denotes a coefficient of the sum of the amounts of time consumed by all the network blocks of the first neural network architecture to access the DRAM, and k₂ denotes a coefficient of the sum of the weights of all the mix operations in the first neural network architecture.

Time consumption of a network block to access the DRAM in the first neural network architecture may include a second sum of amounts of time consumed for all mix operations to access the DRAM in the network block.

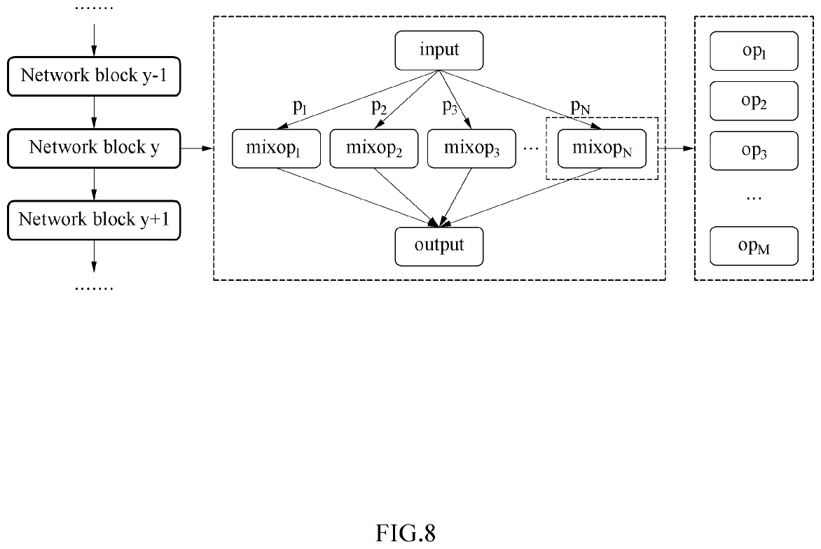

As shown in FIG. 8, one network block may include mix operations mixop₁ through mixop_{N}, a weight of the mix operation mixop₁ may be p₁, a weight of a mix operation mixop₂ may be p₂, and a weight of the mix operation mixop_{N} may be p_{N}. All network blocks y−1, y, and y+1 may be network blocks of the first neural network architecture.

In an example, time consumed by a network block to access the DRAM in the first neural network architecture may be expressed as shown in Equation 3 below.

L_DRAM_{y}=p₁×D(mixop₁)+p₂×D(mixop₂)+ . . . p_{N}×D(mixop_{N}) [Equation 3]

In Equation 3, L_DRAM_{y} denotes time consumption of a network block y to access the DRAM, D(mixop_{N}) denotes time consumption of the mix operation mixop_{N} to access the DRAM, and p_{N} denotes the weight of the mix operation mixop_{N}. N may be a positive integer and may indicate a number of mix operations of a network block.

In an example, time consumed by a mix operation to access the DRAM in a network block may include a sum of amounts of time consumed for all primitive operations to access the DRAM in the mix operation. As shown in FIG. 8, the mix operation mixop_{N} may include primitive operations op₁ to op_{M}. Time consumption of the mix operation mixop_{N} to access the DRAM in the network block may be expressed as shown in Equation 4 below.

D(mixopₘ)=D(op₁)+D(op₁)+ . . . D(op_{M}) [Equation 4]

In Equation 4, D(mixopₘ) denotes the time consumption of the mix operation mixop_{N} to access the DRAM, and D(op_{M}) denotes time consumption of the primitive operation op_{M} to access the DRAM. Time consumption of each primitive operation to access the DRAM may be determined based on a primitive operation, a size, a number of channels, and a size of a feature map. M is a positive integer and denotes a number of primitive operations in a mix operation. An example of a process of determining a mix operation will be further described below.

The target neural network architecture determination apparatus may determine a network block configuration rule, prior to determining a mix operation. For example, the target neural network architecture determination may determine the network block configuration rule, may determine at least one mix operation, and may perform operations 110 to 130. The target neural network architecture determination apparatus may determine the network block configuration rule based on artificial settings, or based on a network block structure. Hereinafter, an example of determining a network block configuration rule of a network block based on a network block structure of a processor will be described.

FIG. 2 illustrates an example of determining a mix operation from a plurality of primitive operations. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently. Referring to FIG. 2, operations 210 to 230 may be performed by the target neural network architecture determination apparatus of FIG. 1. One or more blocks of FIG. 2, and combinations of the blocks, can be implemented by special purpose hardware-based computer, such as a processor, that perform the specified functions, or combinations of special purpose hardware and computer instructions. In addition to the description of FIG. 2 below, the descriptions of FIG. are also applicable to FIG. 2, and are incorporated herein by reference. Thus, the above description may not be repeated here.

In operation 210, the target neural network architecture determination apparatus may obtain a second neural network architecture including at least one network block. The target neural network architecture determination apparatus may fill each network block of the second neural network architecture with at least one candidate combination operation in a set of candidate combination operations, according to the network block configuration rule. Each of the candidate combination operations in the set may include at least one of a plurality of primitive operations.

The second neural network architecture may include at least one network block, and each of the at least one network block may be filled with at least one candidate combination operation. Different types of network blocks may be obtained by filling each network block with different types and/or numbers of candidate combination operations. The second neural network architecture may include one network block, or may include the same type or different types of two or more network blocks.

In an example, a candidate combination operation may include one primitive operation, or may include two or more primitive operations. For example, a plurality of primitive operations may be randomly combined, and at least one of primitive operations combined together may be connected to a candidate combination operation.

The target neural network architecture determination apparatus may connect a plurality of primitive operations to at least one candidate combination operation based on at least one random seed set. Through the above scheme, the target neural network architecture determination apparatus may effectively find out an optimum combination operation by properly increasing a search space.

In operation 220, the target neural network architecture determination apparatus may repeatedly search for the second neural network architecture until a second search end condition is satisfied and searching is stopped.

In an example, the target neural network architecture determination apparatus may use, as a variable element, any one or any combination of a number of network blocks in the second neural network architecture, a scheme of stacking network blocks, and a scheme of filling each network block with candidate operations, to perform a search.

In an example, the target neural network architecture determination apparatus may perform a process of searching for a scheme of filling each network block of the second neural network architecture with candidate combination operations, using a NAS. In this example, each network block itself may be fixed, and the second neural network architecture may be fixed to include one network block, or a configuration of the network block may be one of hyperparameters of training. In other words, the network block and an operation thereof may be obtained through training.

In an example, a process of searching for a second neural network architecture may be a process of changing a network block and/or a candidate combination operation in a current second neural network architecture. A type and/or a number of network blocks in the current second neural network architecture, and a type and/or a number of candidate combination operations included in each of the network blocks may be changed. The target neural network architecture determination apparatus may train and validate the changed second neural network architecture.

In an example, when each second neural network architecture is trained and validated in a search space, the target neural network architecture determination apparatus may train a model of a candidate second neural network architecture using a training set, and may validate the trained model using a validation set in response to training being performed at least one time.

The target neural network architecture determination apparatus may determine the second search end condition according to practical design requirements. For example, satisfying the second search end condition may indicate that a number of searches reaches a preset number, that a search time reaches a preset time, or that a prediction error of the found second neural network architecture satisfies a preset error value condition.

In an example, the error value conditions corresponding to the first neural network architecture and the second neural network architecture may be the same or different.

In operation 230, the target neural network architecture determination apparatus may determine a mix operation of the second neural network architecture based on a search result. For example, the target neural network architecture determination apparatus may determine a candidate combination operation of at least one desirable second neural network architecture found in the searching as a mix operation.

For example, the target neural network architecture determination apparatus may select at least one second neural network architecture in which a prediction error satisfies the error value condition, as a desirable second neural network architecture. In an example, the error value condition may be preset.

Based on operations 210 and 220, the target neural network architecture determination apparatus may select a mix operation from among a plurality of candidate operation combinations based on a search of the second neural network architecture, and may apply the selected mix operation to a search process of the first neural network architecture. Thus, it may be possible to greatly enhance a network accuracy and reduce a network size.

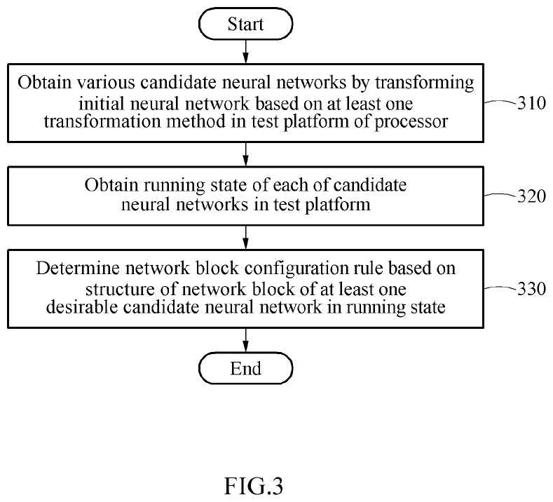

FIG. 3 is a diagram illustrating an example of determining a network block configuration rule based on a desirable network block structure of a processor.

Referring to FIG. 3, operations 310 to 330 may be performed by the target neural network architecture determination apparatus described above with reference to FIGS. 1 and 2.

In operation 310, the target neural network architecture determination apparatus may obtain various candidate neural networks by transforming an initial neural network based on at least one transformation method in a test platform implemented at a processor.

The initial neural network may include at least one network block structure. The initial neural network may include one network block structure, or may include two or more network block structures. Each network block structure of the initial neural network may be transformed based on the same scheme.

For example, the transforming of the initial neural network based on the at least one transformation method in operation 310 may include any one or any combination of horizontally expanding the initial neural network, vertically expanding the initial neural network, performing parallel splitting on a single operation of the initial neural network, changing a size of a feature map of the initial neural network, and changing a number of channels of the initial neural network.

In operation 320, the target neural network architecture determination apparatus may obtain a running state of each of the candidate neural networks in the test platform.

For example, operation 320 may include acquiring a time consumed by each of the candidate neural networks to process the same reference data set in the test platform. A running state may include the time consumed by each of the candidate neural networks to process the same reference data set in the test platform.

In an example, time consumption may be defined as an amount of time consumed by a candidate neural network to process a reference data set. The time consumption may also indicate an amount of reference data processed by a candidate neural network within a unit time, that is, a speed at which the candidate neural network processes the reference data.

Reference data may include, for example, image data, text data, or audio data. For example, when image data is used as reference data, each candidate neural network may identify image data of the same group. To complete a single set of image data, a time consumed for recognition of a candidate neural network, or an amount of image data identified by a candidate neural network in a unit time may be regarded as time consumption. For example, a number of image frames identified by a candidate neural network within one second may be regarded as time consumption.

In operation 330, the target neural network architecture determination apparatus may determine a network block configuration rule based on a structure of a network block of at least one desirable candidate neural network in a running state.

The target neural network architecture determination apparatus may determine at least one desirable candidate neural network based on a time consumed by each candidate neural network to process the reference data set. The any one or any combination of may determine a network block configuration rule based on a structure of a network block in the at least one desirable candidate neural network in the running state.

The target neural network architecture determination apparatus may determine at least one desirable candidate neural network in the running state based on an amount of reference data processed by each candidate neural network within a unit time, and may determine a network block configuration rule based on a structure of a network block in the at least one desirable candidate neural network in the running state.

The target neural network architecture determination apparatus may determine the network block configuration rule based on any one or any combination of a priority relationship between vertical expansion and horizontal expansion, a number of operations obtained by parallel splitting of a single operation, a number of channels, and a size of a feature map.

In an example, the target neural network architecture determination apparatus takes into consideration a preference of processor hardware, determines a network block configuration rule based on a desirable network block structure of the processor, determines a search space based on the network block configuration rule to ensure that a neural network architecture found in searching more closely matches performance of the processor. Thus, providing a neural network architecture with excellent execution performance when running in the processor.

When the second neural network architecture is searched for according to the network block configuration rule determined based on the desirable network block structure of the processor, the target neural network architecture determination apparatus may guarantee that a mix operation obtained through a search more closely matches the performance of the processor so that a corresponding neural network architecture may have better execution performance when running in the processor.

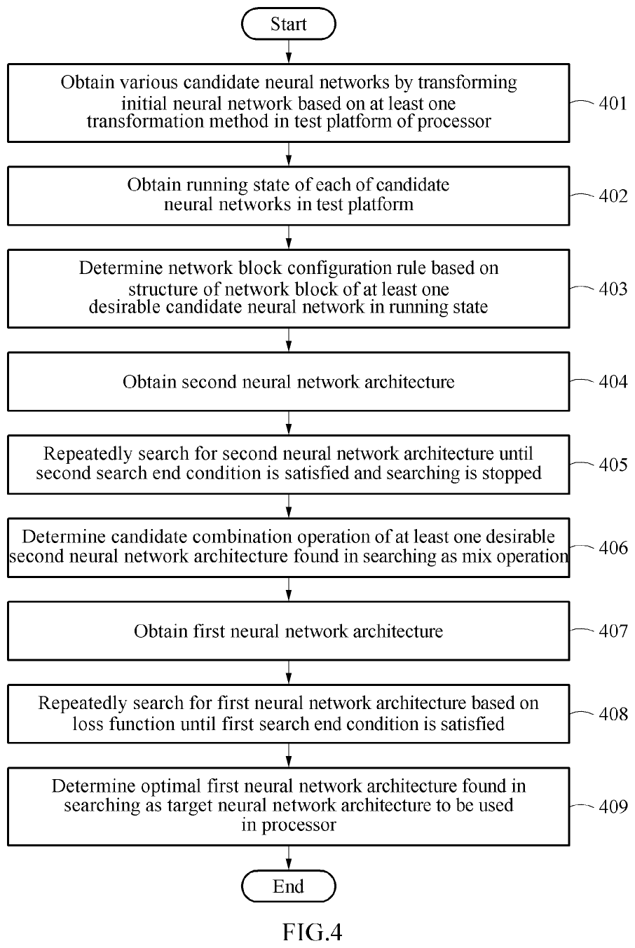

FIG. 4 is a diagram illustrating an example of a search method to determine a neural network architecture of a processor when the processor is an NPU. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently. The above description of FIGS. 1 to 3 may also be applicable to the example of FIG. 4, and accordingly further description is not repeated herein.

Referring to FIG. 4, in operation 401, a target neural network architecture determination apparatus may obtain various candidate neural networks by transforming an initial neural network based on at least one transformation method in a test platform that is implemented at the processor.

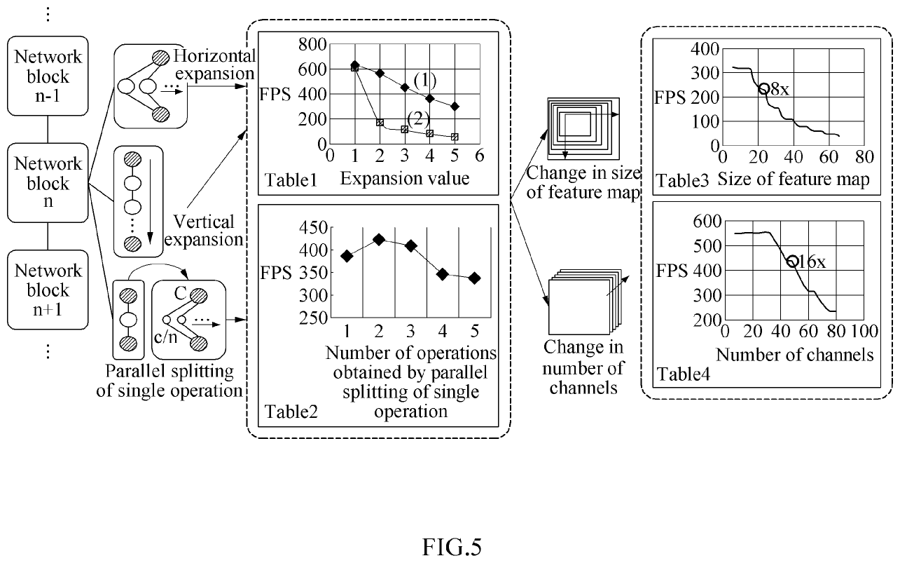

The initial neural network may include a plurality of network block structures. As shown in FIG. 5, a plurality of network block structures may include network blocks n−1, network block n, and n+1, and each of the network block structures of the initial neural network may be transformed based on the same scheme.

In an example, the transforming of the initial neural network based on the at least one transformation method in operation 401 may include any one or any combination of horizontally expanding the initial neural network, vertically expanding the initial neural network, performing parallel splitting on a single operation of the initial neural network, changing a size of a feature map of the initial neural network, and changing a number of channels of the initial neural network.

For example, the target neural network architecture determination apparatus may vertically expand the initial neural network based on different extension values, and may obtain a plurality of first candidate neural networks.

In another example, the target neural network architecture determination apparatus may horizontally expand the initial neural network based on different extension values, and may obtain a plurality of second candidate neural networks.

In another example, the target neural network architecture determination apparatus may perform parallel splitting on a single operation of the initial neural network based on different quantities, and may obtain a plurality of second candidate neural networks.

In another example, the target neural network architecture determination apparatus may change the size of the feature map of the initial neural network to another value, and may obtain a plurality of fourth candidate neural network. Also, the target neural network architecture determination apparatus may change the number of channels of the initial neural network to another value, and may obtain a plurality of fifth candidate neural network.

In an example, an expansion value of horizontal expansion may be an increased number of nodes, and an expansion value of vertical expansion may be an increased number of layers.

In operation 402, the target neural network architecture determination apparatus may obtain a running state of each of the candidate neural networks in the test platform.

For example, operation 402 may include acquiring a time consumed by each of the candidate neural networks to process the same reference data set in the test platform. A running state may include the time consumed by each of the candidate neural networks to process the same reference data set in the test platform.

In an example, time consumption may be defined as an amount of time consumed by a candidate neural network to process a reference data set. The time consumption may also indicate an amount of reference data processed by a candidate neural network within a unit time, that is, a speed at which the candidate neural network processes the reference data.

Reference data may include, for example, image data, text data, or audio data. For example, when image data is used as reference data, each candidate neural network may identify image data of the same group.

In an example, one set of image data may be regarded as one set of reference data, and a number of image frames recognized by a candidate neural network within one second may be regarded as time consumption. A plurality of candidate networks obtained in operation 401 may be used to recognize one set of image data, and the target neural network architecture determination apparatus may determine a number of image frames recognized in each candidate network within one second.

Referring to FIG. 5, in Tables 1 to 4, FPS stands for frames per second and indicates a number of image frames recognized by a candidate network within one second.

A curve (1) of Table 1 indicates a number of image frames recognized by each first candidate neural network within one second when a plurality of first candidate neural networks process one set of images.

A curve (2) of Table 1 indicates a number of image frames recognized by each second candidate neural network within one second when a plurality of second candidate neural networks process one set of images.

A curve of Table 2 indicates a number of image frames recognized by each third candidate neural network within one second when a plurality of third candidate neural networks process one set of images.

A curve of Table 3 indicates a number of image frames recognized by each fourth candidate neural network within one second when a plurality of fourth candidate neural networks process one set of images.

A curve of Table 4 indicates a number of image frames recognized by each fifth candidate neural network within one second when a plurality of fifth candidate neural networks process one set of images.

In operation 403, the target neural network architecture determination apparatus may determine a network block configuration rule based on a structure of a network block of at least one desirable candidate neural network in a running state.

In Table 1, the descending speed of the curve (2) is less than that of the curve (1). In other words, a network block structure of vertical expansion may be a desirable network block structure of the processor in comparison to a candidate neural network obtained by horizontal expansion of an initial neural network. Thus, “prioritizing vertical expansion over horizontal expansion” may be regarded as one of network block configuration rules.

In Table 2, when parallel splitting is performed so that a number of operations obtained by parallel splitting of a single operation of the initial neural network does not exceed four, a number of image frames recognized by a third candidate neural network within one second may increase, and when parallel division is performed so that the number of operations obtained by parallel splitting of a single operation of the initial neural network exceeds four, the number of image frames recognized by the third candidate neural network within one second may decrease. In other words, a network block structure in which the number of operations obtained by the parallel splitting of the single operation does not exceed four may be a desirable network block structure of the processor. Thus, the “number of operations obtained by parallel splitting of a single operation that does not exceed four” may be regarded as one of the network block configuration rules.

The curve of Table 3 may have a shape of a ladder. When a feature map is changed in a ladder of the curve, a number of image frames recognized by a fourth candidate neural network within one second may basically remain unchanged. In other words, an image data processing speed of the fourth candidate neural network may be relatively stable. A size of the feature map corresponding to each ladder of Table 3 may be a multiple of 8 (8×). In other words, a network block structure in which the size of the feature map is a multiple of 8 may be a desirable network block structure of the processor. Thus, “the size of the feature map that is a multiple of 8” may be regarded as one of network block configuration rules.

The curve of Table 4 may have a shape of a ladder. When a number of channels is changed in a ladder of the curve, a number of image frames recognized by a fifth candidate neural network within one second may basically remain unchanged. In other words, an image data processing speed of the fifth candidate neural network may be relatively stable. A number of channels corresponding to each ladder of Table 4 may be a multiple of 16 (16×). In other words, a network block structure in which the number of channels is a multiple of 16 may be a desirable network block structure of the processor. Thus, “the number of channels that is a multiple of 16” may be regarded as one of network block configuration rules.

The network block configuration rules may include any one or any combination of rules describing that vertical expansion is prioritized over horizontal expansion, that the number of operations obtained by parallel splitting of a single operation does not exceed four, that the number of channels is a multiple of 16, and that the size of the feature map is a multiple of 8.

A desirable network block structure of the processor may be related to a type and parameters of the processor. A structure of a network block may be determined based on the type or parameters of the processor. A network block configuration rule may also be determined based on the type or parameters of the processor.

In operation 404, a second neural network architecture may be obtained.

In an example, the target neural network architecture determination apparatus may configure a second neural network architecture with a single network block, or configure a second neural network architecture with a stack of at least one network block.

The network block configuration rule may include all network block configuration rules determined in operation 403. For example, vertical expansion may be prioritized over horizontal expansion, a number of operations obtained by parallel splitting of a single operation may not exceed “4”, a number of channels may be a multiple of 16, and a size of a feature map may be a multiple of 8.

Based on the network block configuration rule determined in operation 403, each network block may be filled with at least one candidate combination operation in a set of candidate combination operations according to different schemes.

In an example, each candidate combination operation in the set may include at least one of a plurality of preset primitive operations. For example, a primitive operation may include at least Conv_1×1, Conv_3×3, Conv_5×5, Conv_3×1_1×3, max_pool_3×3, and sep_conv_3×3. The target neural network architecture determination apparatus may connect the plurality of primitive operations to at least one candidate combination operation, based on at least one random seed set.

In operation 405, the target neural network architecture determination apparatus may repeatedly search for a second neural network architecture until a second search end condition is satisfied and searching is stopped.

In operation 405, the target neural network architecture determination apparatus may use, as a variable element, any one or any combination of a number of network blocks in the second neural network architecture, a scheme of stacking network blocks, and a scheme of filling each network block with candidate operations.

Operation 405 may include a process of searching for a scheme of filling each network block of the second neural network architecture with candidate combination operations using a NAS.

In an example, a process of searching for a second neural network architecture may be a process of changing a second neural network architecture. A type and/or a number of candidate combination operations included in at least one network block in an initial second neural network architecture may be changed. The target neural network architecture determination apparatus may train and validate the initial second neural network architecture in which a change in the candidate combination operations is completed, may obtain a next second neural network architecture, and may determine a prediction error thereof.

For example, the target neural network architecture determination apparatus may use a portion of an image data set as a training set and use another portion of the image data set as a validation set, to train and validate a second neural network architecture in which a change in candidate combination operations is completed. The training set may be used for modeling of the second neural network architecture in which the change in the candidate combination operations is completed. When the second neural network architecture is trained at least one time, the trained second neural network architecture may be validated using the validation set.

When a candidate combination operation of the initial second neural network architecture is changed, the target neural network architecture determination apparatus may determine a scheme of changing a current candidate combination operation based on a prediction error of a previous second neural network architecture. In an example, the scheme of changing the current candidate combination operation based on the prediction error of the previous second neural network architecture may be predetermined.

The target neural network architecture determination apparatus may determine the second search end condition according to practical design requirements. For example, satisfying the second search end condition may indicate that a number of searches reaches a preset number, that a search time reaches a set time, or that a prediction error of the found second neural network architecture satisfies an error value condition.

In an example, the error value conditions corresponding to the first neural network architecture and the second neural network architecture may be the same or different.

In operation 406, the target neural network architecture determination apparatus may determine a candidate combination operation of at least one desirable second neural network architecture found in the searching as a mix operation.

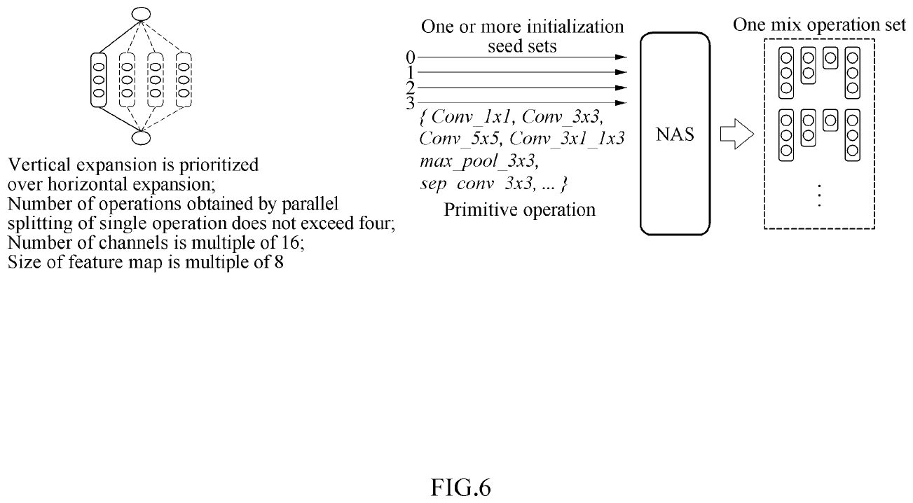

In an example, the target neural network architecture determination apparatus may select at least one second neural network architecture in which a prediction error satisfies the preset error value condition, as a desirable second neural network architecture. In operation 406, one mix operation set may be obtained as shown in FIG. 6.

In operation 407, the target neural network architecture determination apparatus may obtain a first neural network architecture.

The first neural network architecture may include at least one structure, and each structure may include at least one network block. A corresponding network block may be regarded as a unit forming the first neural network architecture. Each network block may be filled with at least one mix operation connected to at least one primitive operation.

In an example, a plurality of structures may be sequentially distributed in a first direction, and each of the structures may be connected to two neighboring structures in the first direction. For example, referring to FIG. 7, the structures 1 to X may be sequentially distributed in the first direction, the structures 1 and 2 may be connected, and the structures 2 and 3 may be connected.

In an example, the first neural network architecture may further include a reduction layer, and each reduction layer may include at least one network block. Structures may be connected to each other via a reduction layer. In FIG. 7, the structures 1 to X may be sequentially distributed in the first direction, the structures 1 and 2 may be connected via the reduction layer 1, and the structures 2 and 3 may be connected via the reduction layer 2.

For example, a number of network blocks included in each structure and a number of network blocks included in each reduction layer may be set in advance according to practical design requirements, or may be determined through training during a repeated process.

As shown in FIG. 7, the structure 1 may include “n1” network blocks, and the structure 2 may include “n2” network blocks. The structure X may include “nx” network blocks, and each reduction layer may include one network block. A single neural network architecture may include “(n1+n2+ . . . nx+n−1)” network blocks in total.

Each structure (or each reduction layer) and a type of network blocks may include the same number and type of network blocks or different numbers and types of network blocks. For example, when one structure (or a reduction layer) is filled with two or more network blocks, types of two network blocks in the structure (or the reduction layer) may be the same or different.

For example, operation 407 may include obtaining an initial first neural network architecture including at least one structure. Each structure may be formed by stacking at least one network block, and a network block of each structure may be filled with at least one mix operation based on a network block configuration rule. A mix operation may be connected to at least one primitive operation.

In operation 408, the target neural network architecture determination apparatus may repeatedly search for the first neural network architecture based on a loss function until a first search end condition is satisfied.

Operation 408 may include a process of searching for each network block from the first neural network architecture and a process of searching for a scheme of filling each network block with a mix operation using the NAS based on the processor-related loss function.

For example, when each first neural network architecture is trained and validated in a search space, the target neural network architecture determination apparatus may train a model of a candidate first neural network architecture using a training set. When training is performed at least one time, the target neural network architecture determination apparatus may validate the trained model using a validation set.

The target neural network architecture determination apparatus may determine the first search end condition according to practical design requirements. For example, satisfying the first search end condition may indicate that a number of searches reaches a set number, that a search time reaches a preset time, or that a value of a processor-related loss function corresponding to the found first neural network architecture satisfies a value condition.

In the model training process, the target neural network architecture determination apparatus may continue to calculate a value of the processor-related loss function. The processor-related loss function may include a processor computation cost part and a prediction error part in a model training process. The prediction error part may be obtained using a validation set for validating a trained model, and the processor computation cost part may include a time-consuming hyperparameter generated by the processor accessing a DRAM in a process of training a model.

In operation 409, the target neural network architecture determination apparatus may determine an optimal first neural network architecture found in the searching as a target neural network architecture to be used in the processor. For example, the optimal first neural network architecture may be a first neural network architecture having a loss function corresponding to an optimal value.

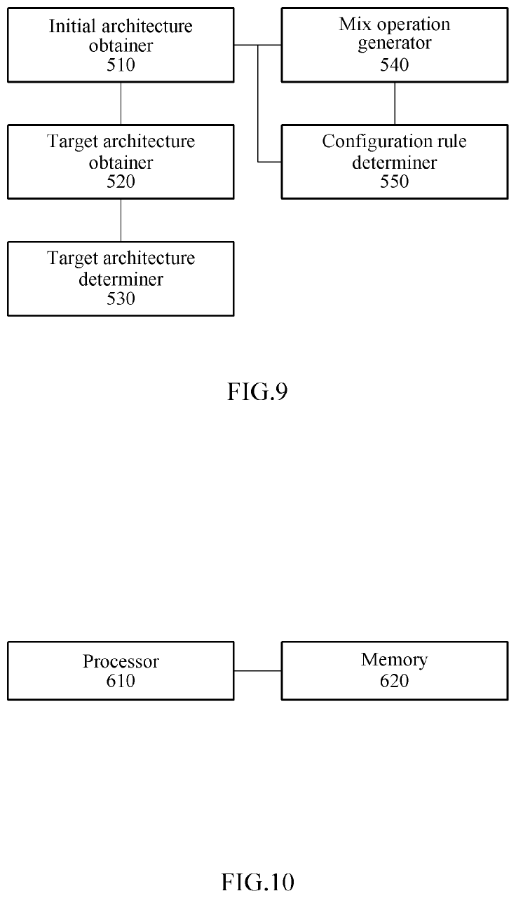

FIG. 9 illustrates an example of a target neural network architecture determination apparatus for determining a neural network architecture of a processor.

Functional units of FIG. 9 may be combined or divided into sub-units without departing from the spirit and scope of the illustrative examples described. Accordingly, description of the present specification may support any possible combination or division of the functional units described herein.

Hereinafter, an example of a function unit that may be included in the target neural network architecture determination apparatus, and an operation of each function unit will be briefly described. The above description of FIGS. 1 to 8 may also be applicable to the example of FIG. 9, and accordingly further description is not repeated herein.

Referring to FIG. 9, the target neural network architecture determination apparatus may include an initial architecture obtainer 510, a target architecture obtainer 520, and a target architecture determiner 530.

The initial architecture obtainer 510 may be configured to obtain a first neural network architecture. The target architecture obtainer 520 may be configured to repeatedly search for the first neural network architecture based on a processor-related loss function until a first search end condition is satisfied and searching is stopped. The target architecture determiner 530 may be configured to determine an optimal first neural network architecture found in the searching as a target neural network architecture that is to be used in the processor. The processor-related loss function may include a processor computation cost part and a prediction error part in a model training process.

The processor computation cost part may include a time-consuming hyperparameter and/or a power-consuming hyperparameter used by the process to access a DRAM in a process of training a model.

In an example, the initial architecture obtainer 510 may be configured to obtain a first neural network architecture including at least one structure. Each of the at least one structure may be formed by stacking at least one network block, and a network block of each of the at least one structure may be filled with the at least one mix operation based on a network block configuration rule of the network block. The mix operation may be connected to at least one primitive operation.

The target neural network architecture determination apparatus may further include a mix operation generator 540. The mix operation generator 540 may obtain a second neural network architecture including at least one network block. Based on a network block configuration rule, each network block of the second neural network architecture may be filled with at least one candidate combination operation in a set of candidate combination operations, and each of the candidate combination operations may include at least one of a plurality of primitive operations. The mix operation generator 540 may be configured to repeatedly search for the second neural network architecture until a second search end condition is satisfied and searching is stopped, and to determine a candidate combination operation of at least one desirable second neural network architecture found in the search as a mix operation.

The target neural network architecture determination apparatus may further include a configuration rule determiner 550. The configuration rule determiner 550 may be configured to determine a network block configuration rule based on artificial setting and/or a desirable network block structure of the processor.

In an example, the configuration rule determiner 550 may be configured to obtain various candidate neural networks by transforming an initial neural network based on at least one transformation method in a test platform of a processor, to obtain a running state of each of the candidate neural networks in the test platform, and to determine a network block configuration rule based on a structure of a network block of at least one desirable candidate neural network in a running state.

The configuration rule determiner 550 may be configured to obtain a time consumed by each of the candidate neural networks to process the same reference data set in the test platform. A running state may include the time consumed by each of the candidate neural networks to process the same reference data set in the test platform.

In an example, the configuration rule determiner 550 may be configured to perform any one or any combination of horizontally extending the initial neural network; vertically extending the initial neural network; performing parallel splitting on a single operation of the initial neural network; changing a size of a feature map of the initial neural network; and changing a number of channels of the initial neural network.

In an example, the network block configuration rule may include any one or any combination of a priority relationship between vertical expansion and horizontal expansion; a number of operations obtained by parallel splitting of a single operation; a number of channels; and a size of a feature map.

FIG. 10 illustrates an example of a computing device.

Referring to FIG. 10, a computing device may include a processor 610 and a memory 620.

The memory 620 may store a computer program, and a search method to determine a neural network architecture of a processor may be implemented when the computer program is executed by the processor 610.

The processor 610 may be, for example, a data processing device implemented by hardware including a circuit having a physical structure to perform desired operations. The processor 610 may be implemented or executed by combining various logic blocks, modules, and circuits that are described in the present application. For example, the desired operations may include code or instructions included in a program. For example, the hardware-implemented data processing device may include for example, a microprocessor, a microprocessor, single processor, independent processors, parallel processors, single-instruction single-data (SISD) multiprocessing, single-instruction multiple-data (SIMD) multiprocessing, multiple-instruction single-data (MISD) multiprocessing, multiple-instruction multiple-data (MIMD) multiprocessing, a microcomputer, a processor core, a multi-core processor, and a multiprocessor, a central processing unit (CPU), an application-specific integrated circuit (ASIC), and a field-programmable gate array (FPGA), a central processing unit (CPU), a controller and an arithmetic logic unit (ALU), a digital signal processor (DSP), a graphics processing unit (GPU), or an application processor (AP), a neural processing unit (NPU), or a programmable logic unit (PLU). Further description of the processor 610 is provided below.

The memory 620 may include, for example, a read-only memory (ROM) or another static storage device for storing static information and command, a random-access memory (RAM) or another dynamic storage device for storing information and command, or an electrically erasable programmable read-only memory (EEPROM), a compact disc (CD)-ROM, or another optical disc storage device, optical disk storage devices (for example, a CD, laser disks, optical disks, digital general-purpose optical disks, Blu-ray disks, etc.), disk storage media or other magnetic storage devices, or other medium that is used to carry or store desired program code in the form of instructions or data structures and that may be accessed by a computer, but is not limited thereto.

Depending on examples, a non-transitory computer-readable storage medium having instructions stored thereon may be further provided. When instructions are executed by at least one computing device, the at least one computing device may be prompted to perform a search method to determine a neural network architecture of a processor. The non-transitory computer-readable storage medium may be a data storage device that may store data read from a computer system. The non-transitory computer-readable storage medium may include, for example, a ROM, a RAM, a CD-ROM, a magnetic tape, a floppy disk, an optical data storage device, and a carrier (for example, a data transmission through the Internet via a wired or wireless transmission path). Further description of the memory 620 is provided below.

The initial architecture obtainer 510, target architecture obtainer 520, target architecture determiner 530, mix operation generator 540, configuration rule determiner 550, and other apparatuses, units, modules, devices, and components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, multiple-instruction multiple-data (MIMD) multiprocessing, a controller and an arithmetic logic unit (ALU), a DSP, a microcomputer, an application-specific integrated circuit (ASIC), a field programmable gate array (FPGA), a programmable logic unit (PLU), a central processing unit (CPU), a graphics processing unit (GPU), a neural processing unit (NPU), or any other device capable of responding to and executing instructions in a defined manner.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In an example, the instructions or software includes at least one of an applet, a dynamic link library (DLL), middleware, firmware, a device driver, an application program storing the method of determining a target neural network architecture. In another example, the instructions or software include higher-level code that is executed by the processor or computer using an interpreter. The instructions or software may be written using any programming language based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), magnetic RAM (MRAM), spin-transfer torque(STT)-MRAM, static random-access memory (SRAM), thyristor RAM (T-RAM), zero capacitor RAM (Z-RAM), twin transistor RAM (TTRAM), conductive bridging RAM(CBRAM), ferroelectric RAM (FeRAM), phase change RAM (PRAM), resistive RAM(RRAM), nanotube RRAM, polymer RAM (PoRAM), nano floating gate Memory(NFGM), holographic memory, molecular electronic memory device), insulator resistance change memory, dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions. In an example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of determining a target neural network architecture, the method comprising:
obtaining a first neural network architecture;
searching for the first neural network architecture based on a loss function, in response to a first search end condition not being satisfied; and
determining a target neural network architecture used in a processor, based on a result of the searching,
wherein the loss function is based on a processor computation cost.

2. The method of claim 1, wherein the loss function is based on the processor computation cost and a prediction error in a training of the first neural network architecture.

3. The method of claim 1, wherein
the processor computation cost comprises any one or any combination of a time-consuming hyperparameter and a power-consuming hyperparameter,
the time-consuming hyperparameter is determined based on a time to access a memory when the processor trains the first neural network architecture, and
the power-consuming hyperparameter is based on power consumed to access a memory when the processor trains the first neural network architecture.

4. The method of claim 1, wherein
the first neural network architecture comprises at least one structure,
the at least one structure is formed by stacking at least one network block,
the at least one network block comprises at least one mix operation, and
the at least one mix operation is connected to at least one primitive operation.

5. The method of claim 4, wherein the at least one mix operation is determined by:
obtaining a second neural network architecture;
searching for the second neural network architecture, in response to a second search end condition not being satisfied; and
determining a mix operation of the second neural network architecture based on a result of the searching for the second neural network.

6. The method of claim 5, wherein
the second neural network architecture comprises at least one network block,
the at least one network block comprises at least one candidate combination operation based on a network block configuration rule of the at least one network block, and
the at least one candidate combination operation comprises at least one of a plurality of primitive operations.

7. The method of claim 6, further comprising:
determining the network block configuration rule based on artificial settings.

8. The method of claim 6, further comprising:
determining the network block configuration rule based on a network block structure of the processor.

9. The method of claim 8, wherein the determining of the network block configuration rule based on the network block structure of the processor comprises:
obtaining one or more candidate neural networks by transforming an initial neural network based on at least one transformation scheme in a test platform of the processor;
obtaining a running state of each of the one or more candidate neural networks in the test platform; and
determining the network block configuration rule based on the running state of each of the one or more candidate neural networks.

10. The method of claim 9, wherein the obtaining of the running state comprises obtaining a time consumed by each of the one or more candidate neural networks to process a reference data set in the test platform.

11. The method of claim 9, wherein the obtaining of the one or more candidate neural networks comprises any one or any combination of:
horizontally expanding the initial neural network;
vertically expanding the initial neural network;
performing parallel splitting on a single operation of the initial neural network;
changing a size of a feature map of the initial neural network; and
changing a number of channels of the initial neural network.

12. The method of claim 8, wherein the network block configuration rule is determined based on any one or any combination of a priority relationship between vertical expansion and horizontal expansion, a number of operations obtained by parallel splitting of a single operation, a number of channels, and a size of a feature map.

13. A non-transitory computer-readable storage medium storing instructions that, when executed by a processor, cause the processor to perform the method of claim 1.

14. A target neural network architecture determination apparatus, the apparatus comprising:
a processor configured to obtain a first neural network architecture, to search for the first neural network architecture based on a loss function, in response to a first search end condition not being satisfied, and to determine a target neural network architecture used in the processor, based on a result of the searching,
wherein the loss function is based on a processor computation cost.

15. The apparatus of claim 14, wherein
the processor computation cost comprises any one or any combination of a time-consuming hyperparameter and a power-consuming hyperparameter,
the time-consuming hyperparameter is determined based on a time to access a memory when the processor trains the first neural network architecture, and
the power-consuming hyperparameter is based on power consumed to access a memory when the processor trains the first neural network architecture.

16. The apparatus of claim 14, wherein
the first neural network architecture comprises at least one structure,
the at least one structure is formed by stacking at least one network block,
the at least one network block comprises at least one mix operation, and
the at least one mix operation is connected to at least one primitive operation.

17. The apparatus of claim 16, wherein the processor is further configured to:
obtain a second neural network architecture;
search for the second neural network architecture, in response to a second search end condition not being satisfied; and
determine a mix operation of the second neural network architecture based on a result of the searching for the second neural network.

18. The apparatus of claim 17, wherein
the second neural network architecture comprises at least one network block,
the at least one network block comprises at least one candidate combination operation based on a network block configuration rule of the at least one network block, and
the at least one candidate combination operation comprises at least one of a plurality of primitive operations.

19. The apparatus of claim 18, wherein the processor is further configured to determine the network block configuration rule based on a network block structure of the processor.

20. The apparatus of claim 19, wherein the processor is further configured to:
obtain one or more candidate neural networks by transforming an initial neural network based on at least one transformation scheme in a test platform of the processor;
obtain a running state of each of the one or more candidate neural networks in the test platform; and
determine the network block configuration rule based on the running state of each of the one or more candidate neural networks.
